(19) United States
(12) Patent Application Publication
(10) Pub. No.: US 2019/0232635 A1
(43) Pub. Date: Aug. 1, 2019

(54) WEB CONVEYING DEVICE

(71) Applicant: RISO KAGAKU CORPORATION, Tokyo (JP)

(72) Inventor: Kazuyuki AOKI, Ibaraki (JP)

(73) Assignee: RISO KAGAKU CORPORATION, Tokyo (JP)

(21) Appl. No.: 16/256,700

(22) Filed: Jan. 24, 2019

(30) Foreign Application Priority Data
Jan. 29, 2018 (JP) 2018-012580

(51) Int. Cl. B41F 13/02; B65G 13/07; B65G 13/075; F16D 65/14; B41J 15/04

(52) U.S. Cl. CPC B41F 13/02; B65G 13/07; F16D 2121/24; F16D 65/14; B41J 15/048; B65G 13/075

(57) ABSTRACT

A controller, upon a web roll being set on a web roll support shaft: drives a brake to apply a braking force of a first value to the web roll support shaft, the first value being a value at which the web roll does not rotate when a predetermined tension is applied to a web, and drives a conveyance motor to generate a drive force for the predetermined tension; drives the brake with the drive force generated to gradually reduce the braking force from the first value while determining whether rotation of a conveyance roller starts; and upon determining that the rotation of the conveyance roller starts, determines a second value of the braking force as an initial value of the braking force in conveyance of the web for printing, the second value being a value at which the rotation of the conveyance roller starts.

### CROSS REFERENCE TO RELATED APPLICATION

This application is based upon and claims the benefit of priority from the prior Japanese Patent Application No. 2018-012580, filed on Jan. 29, 2018, the entire contents of which are incorporated herein by reference.

### BACKGROUND

### 1. Technical Field

The disclosure relates to a conveying device which conveys a web.

### 2. Related Art

Japanese Patent Application Publication No. 2011-79651 describes a printing apparatus which prints an image on a long web as a print medium while conveying the web.

Among such printing apparatuses, there is one which prints an image on a web by using an inkjet head while causing a conveyance roller to unwind and convey the web from a web roll being the web wound into a roll and causing a brake mechanism to apply a brake to rotation of the web roll.

In such a printing apparatus, appropriate tension for obtaining excellent print image quality is applied to the web by applying the brake to the rotation of the web roll. Moreover, since the outer diameter of the web roll gradually becomes smaller with the unwinding of the web, the braking force of the brake mechanism is controlled and changed depending on the outer diameter of the web roll such that the tension of the web is constant.

In this case, the outer diameter of the web roll can be calculated based on the conveyance speed of the web (number of revolutions of the conveyance roller) and the number of revolutions of the brake mechanism (number of revolutions of the web roll). When a web roll is newly set, the printing apparatus performs an initial operation including conveying the web for roll diameter calculation and calculating the outer diameter of the web roll based on the conveyance speed of the web and the number of revolutions of the brake mechanism in this conveyance.

Then, the printing apparatus sets the initial value of the braking force of the brake mechanism in conveyance of the web for executing printing based on the calculated outer diameter of the web roll. During the conveyance of the web for executing the printing, the printing apparatus calculates the outer diameter of the web roll in real time and controls the braking force of the brake mechanism depending on the calculation result such that the tension of the web is constant.

### SUMMARY

In a technique in which the outer diameter of the newly-set web roll is calculated by conveying the web for roll diameter calculation as described above, a portion of the web conveyed for the roll diameter calculation cannot be used for printing and is wasted (becomes waste paper).

Meanwhile, the conveyance of the web for roll diameter calculation can be omitted if the outer diameter of the newly-set web roll is detected with a sensor or the like in the printing apparatus and the initial value of the braking force is set based on the detected outer diameter. However, in this case, the sensor or the like for detecting the outer diameter of the web roll needs to be provided in the printing apparatus and the complexity of the apparatus configuration increases.

Moreover, the conveyance of the web for roll diameter calculation can be omitted also if a user inputs the outer diameter of the web roll on an operation input portion of the printing apparatus. However, in this case, the user needs to perform the operation of inputting the outer diameter of the web roll and the convenience decreases. Particularly, when the partially-used web roll is set to the printing apparatus, the outer diameter of this web roll is unknown. Thus, the user needs to measure the outer diameter of the web roll and the convenience further decreases.

The disclosure is directed to a conveying device which can avoid an increase in the complexity of the apparatus configuration and a decrease in the convenience of the user while reducing the amount of web to be wasted.

A conveying device in accordance with some embodiments includes: a web roll support shaft configured to rotatably support a web roll; a brake configured to apply a braking force to the web roll support shaft; a conveyance roller configured to convey a web while unwinding the web from the web roll; a conveyance motor configured to drive the conveyance roller; and a controller configured to drive the brake and the conveyance motor such that the web is unwound and conveyed from the web roll by the conveyance roller while the braking force is applied to the web roll support shaft to brake rotation of the web roll and thereby apply a predetermined tension to the web in printing. Upon the web roll being set on the web roll support shaft, the controller is configured to: drive the brake to apply the braking force of a first value to the web roll support shaft, the first value being a value at which the web roll does not rotate when the predetermined tension is applied to the web, and drive the conveyance motor to generate a drive force for the predetermined tension; drive the brake with the drive force generated to gradually reduce the braking force from the first value while determining whether rotation of the conveyance roller starts; and upon determining that the rotation of the conveyance roller starts, determine a second value of the braking force as an initial value of the braking force in conveyance of the web for the printing, the second value being a value at which the rotation of the conveyance roller starts.

In the aforementioned configuration, it is possible to avoid an increase in the complexity of the apparatus configuration and a decrease in the convenience of the user while reducing the amount of web to be wasted.

### BRIEF DESCRIPTION OF DRAWINGS

FIG. 1 is a schematic configuration diagram of a printing apparatus including a conveying device according to the embodiment.

FIG. 2 is an enlarged perspective view of a main portion of a web roll holder in the printing apparatus illustrated in FIG. 1.

FIG. 3 is a control block diagram of the printing apparatus illustrated in FIG. 1.

FIG. 4 is a flowchart for explaining an initial operation.

FIG. 5 is an explanatory view of a method of determining an initial value of braking force in the initial operation

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

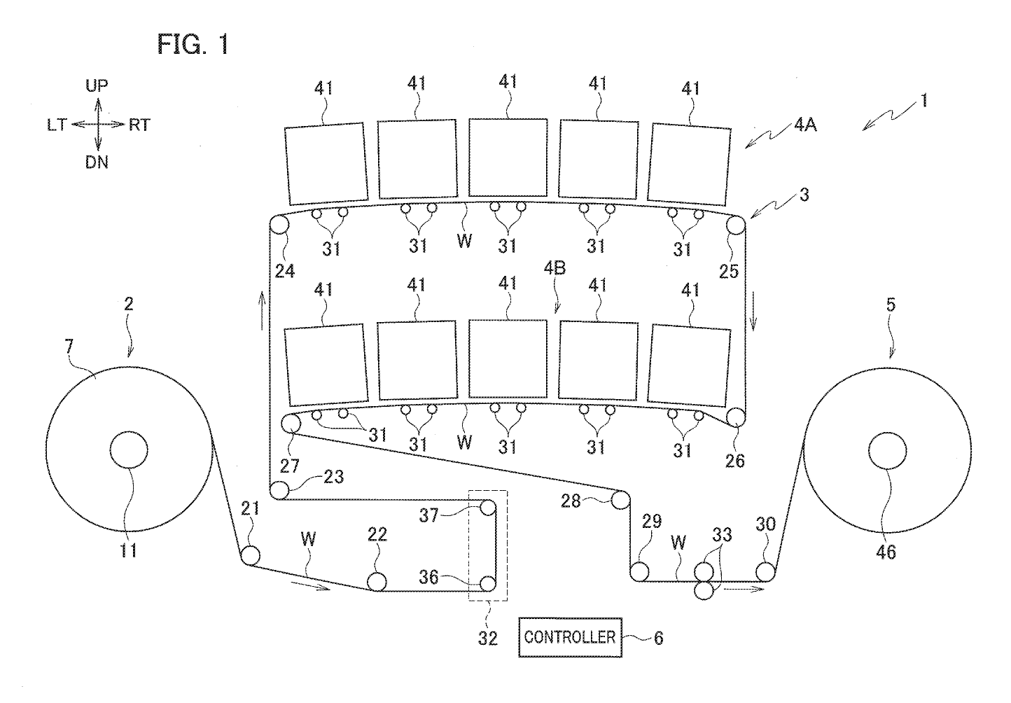

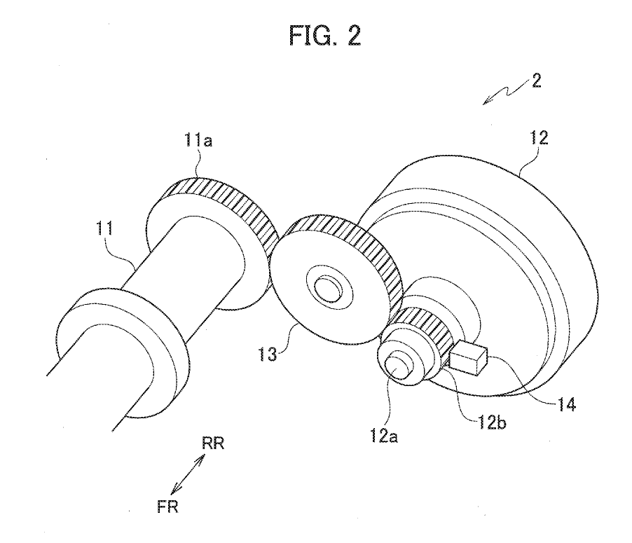

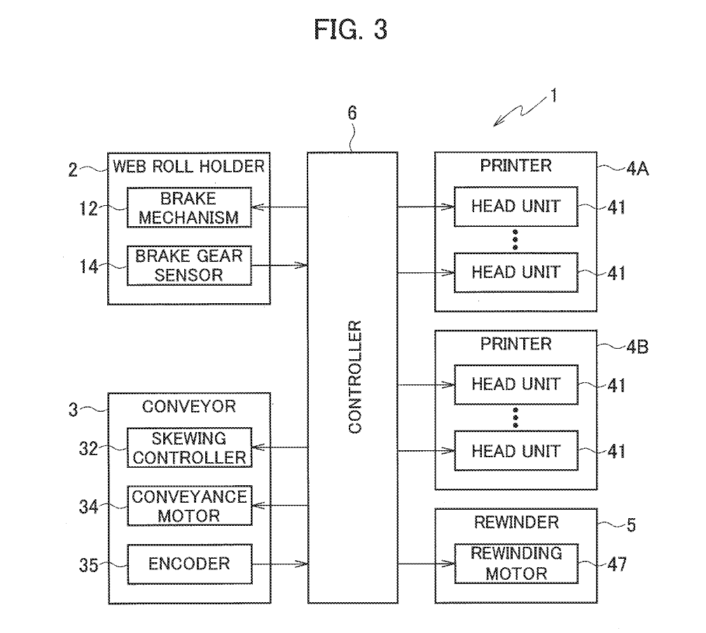

FIG. 1 is a schematic configuration diagram of a printing apparatus including a conveying device according to the embodiment. FIG. 2 is an enlarged perspective view of a main portion of a web roll holder in the printing apparatus illustrated in FIG. 1. FIG. 3 is a control block diagram of the printing apparatus illustrated in FIG. 1. Note that, in the following description, the direction orthogonal to the sheet surface of FIG. 1 is referred to as front-rear direction and the direction from the sheet surface toward the viewer is referred to as front. Up, down, left, and right on the sheet surface of the FIG. 1 are referred to as up, down, left, and right, respectively. In FIGS. 1 and 2, the directions of right, left, up, down, front, and rear are denoted by RT, LT, UP, DN, FR, and RR, respectively.

As illustrated in FIGS. 1 and 3, the printing apparatus 1 according to the embodiment includes a web roll holder 2, a conveyor 3, printers 4A, 4B, a rewinder 5, and a controller 6. Note that the web roll holder 2, the conveyor 3, and the controller 6 form the conveying device.

The web roll holder 2 holds a web roll 7. The web roll 7 is a roll of a web W which is a long print medium made of film, paper, or the like. As illustrated in FIGS. 1 to 3, the web roll holder 2 includes a web roll support shaft 11, a brake mechanism 12, an intermediate gear 13, and a brake gear sensor 14.

The web roll support shaft 11 supports the web roll 7 in a rotatable manner. The web roll support shaft 11 is formed in a long shape extending in a front-rear direction. The web roll support shaft 11 is formed of, for example, an air shaft. A web roll support shaft gear 11a meshing with the intermediate gear 13 is fixed to a rear end of the web roll support shaft 11.

The brake mechanism 12 applies braking force to the web roll support shaft 11. Specifically, the brake mechanism 12 applies torque (load torque) to the web roll support shaft 11 in a direction opposite to the rotating direction of the web W in unwinding (clockwise in FIG. 1). The brake mechanism 12 is formed of, for example, a powder brake.

The brake mechanism 12 includes an output shaft 12a which outputs the braking force (load torque). A brake gear 12b is attached to the output shaft 12a. The braking force of the brake mechanism 12 is transmitted to the web roll support shaft 11 via the brake gear 12b, the intermediate gear 13, and the web roll support shaft gear 11a to be applied to the web roll support shaft 11.

The intermediate gear 13 transmits the braking force of the brake mechanism 12 to the web roll support shaft gear 11a. The intermediate gear 13 meshes with the web roll support shaft gear 11a and the brake gear 12b.

The brake gear sensor 14 detects teeth of the brake gear 12b.

The conveyor 3 conveys the web W. The conveyor 3 includes guide rollers 21 to 30, twenty under-head rollers 31, a skewing controller 32, a pair of conveyance rollers 33, a conveyance motor 34, and an encoder 35.

The guide rollers 21 to 30 guide the web W conveyed in the conveyor 3. The guide rollers 21 to 30 rotate by following the conveyed web W. The guide rollers 21 to 30 are formed in a long shape extending in the front-rear direction. The guide rollers 21 to 30, the under-head rollers 31, the conveyance rollers 33, and skewing control rollers 36, 37 of the skewing controller 32 to be described later form a conveyance route of the web W in the conveyor 3.

The guide rollers 21, 22 guide the web W between the web roll 7 and the skewing controller 32. The guide roller 21 is arranged near and on the right side of the web roll holder 2. The guide roller 22 is arranged between the guide roller 21 and the skewing control roller 36 of the skewing controller 32 to be described later.

The guide rollers 23 to 29 guide the web W between the skewing controller 32 and the pair of the conveyance rollers 33. The guide roller 23 is arranged slightly above and on the left side of the skewing control roller 37 of the skewing controller 32 to be described later. The guide roller 24 is arranged above the guide roller 23. The guide roller 25 is arranged on the right side of the guide roller 24 at the same height as the guide roller 24. The guide roller 26 is arranged below the guide roller 25 and above the guide roller 23. The guide roller 27 is arranged on the left side of the guide roller 26, near and on the right side of the web W between the guide rollers 23, 24, at substantially the same height as the guide roller 26. The guide roller 28 is arranged on the lower right side of the guide roller 27. The guide roller 29 is arranged below and slightly on the right side of the guide roller 28.

The guide roller 30 guides the web W between the pair of conveyance rollers 33 and the rewinder 5. The guide roller 30 is arranged near and on the left side of the rewinder 5.

The under-head rollers 31 support the web W below later-described head units 41 between the guide rollers 24 and 25 and between the guide rollers 26 and 27. The under-head rollers 31 are formed in a long shape extending in the front-rear direction. Ten under-head rollers 31 are arranged in each of an area between the guide rollers 24 and 25 and an area between the guide rollers 26 and 27. Moreover, two under-head rollers 31 are arranged directly below each head unit 41. The under-head rollers 31 rotate by following the conveyed web W.

The skewing controller 32 corrects skewing which is fluctuation in the position of the web W in the width direction thereof (front-rear direction). The skewing controller 32 includes the skewing control rollers 36, 37.

The skewing control rollers 36, 37 are rollers for guiding the web W and correcting the skewing of the web W. The skewing control rollers 36, 37 are formed in a long shape extending in the front-rear direction. The skewing control rollers 36, 37 rotate by following the conveyed web W. The skewing control rollers 36, 37 are turned by a not-illustrated motor to be tilted with respect to the width direction of the web W as viewed in the left-right direction and thereby move the web W in the width direction to correct the skewing. The skewing control roller 36 is arranged on the right side of the guide roller 22. The skewing control roller 37 is arranged above the skewing control roller 36.

The pair of conveyance rollers 33 conveys the web W toward the rewinder 5 while nipping the web W. Conveyance of the web W by the conveyance rollers 33 causes the web roll 7 to rotate together with the web roll support shaft 11 and the web W is unwound from the web roll 7. One of the paired conveyance rollers 33 is rotationally driven by the conveyance motor 34 and the other conveyance roller 33 rotates by following the one conveyance roller 33. The pair of conveyance rollers 33 is arranged between the guide rollers 29, 30.

The conveyance motor 34 rotationally drives one of the paired conveyance rollers 33.

The encoder 35 outputs a pulse signal every time an output shaft of the conveyance motor 34 rotates by a predetermined angle.

The printers 4A, 4B print images respectively on a front side and a back side of the web W. The printer 4A is arranged near and above the web W between the guide rollers 24, 25. The printer 4B is arranged near and above the web W between the guide rollers 26, 27. Each of the printers 4A, 4B includes five head units 41.

The head units 41 include inkjet heads (not illustrated) and print images by ejecting inks from nozzles of the inkjet heads to the web W. The five head units 41 eject inks of different colors, respectively, in each of the printers 4A, 4B.

The rewinder 5 rewinds the web W subjected to printing in the printers 4A, 4B. The rewinder 5 includes a rewinding shaft 46 and a rewinding motor 47.

The rewinding shaft 46 rewinds and holds the web W. The rewinding shaft 46 is formed in a long shape extending in the front-rear direction.

The rewinding motor 47 rotates the rewinding shaft 46 clockwise in FIG. 1. Rotation of the rewinding shaft 46 causes the web W to be rewound on the rewinding shaft 46.

The controller 6 controls operations of the entire printing apparatus 1. The controller 6 includes a CPU, a RAM, a ROM, a hard disk drive, and the like.

When printing is to be performed, the controller 6 controls the brake mechanism 12, the conveyance motor 34, and the rewinding motor 47 such that the web W is unwound and conveyed from the web roll 7 by the conveyance rollers 33 and rewound by the rewinder 5 while the braking force is applied to the web roll support shaft 11 to apply a brake to the rotation of the web roll 7 and thereby apply predetermined set tension Fs to the web W. Moreover, the controller 6 prints images by causing the inks to be ejected from the head units 41 of the printers 4A, 4B to the conveyed web W.

Moreover, when the web roll 7 is set on the web roll support shaft 11, the controller 6 executes, for example, an initial operation for determining an initial value of the braking force of the brake mechanism 12 in the conveyance of the web W for executing the printing. The initial value of the braking force of the brake mechanism. 12 is the braking force (torque) set when the conveyance of the web W is started for the first time after the setting of the web roll 7 on the web roll support shaft 11.

Specifically, when the web roll 7 is set on the web roll support shaft 11, the controller 6 causes the brake mechanism 12 to generate the maximum braking force to be described later while causing the conveyance motor 34 to generate drive force (torque) for the set tension Fs and, from this state, gradually reduces the braking force of the brake mechanism. 12. Then, the controller determines the braking force of the brake mechanism 12 at the moment when the conveyance rollers 33 start to rotate as the initial value of the braking force in the conveyance of the web W.

The controller 6 stores a set tension table (not illustrated) in which the type and width of the web W are associated with the set tension Fs. Here, the type of web W includes a thick sheet, a thin sheet, a sheet with perforation, and the like. If the width is the same, the lower the stiffness of the type of the web W is, the smaller the set tension Fs is. Moreover, if the type is the same, the smaller the width of the web W is, the smaller the set tension Fs is. Using the set tension Fs depending on the type and width of the web W can prevent damage to the web W caused by excessive tension, contact of the web W with the inkjet heads caused by slacking of the web W due to insufficient tension, and a decrease in print image quality.

Next, description is given of the initial operation performed when the web roll 7 is set on the web roll support shaft 11 of the printing apparatus 1.

When the web roll 7 is newly set on the web roll support shaft 11, the user performs work of laying the web W along the conveyance route from the web roll holder 2 to the rewinder 5 via the conveyor 3. The web roll 7 newly set in this case is not limited to a new roll and may be a partially-used roll.

After the work of laying the web W, the user performs an input operation of instructing start of the initial operation on a not-illustrated operation panel. Moreover, in this case, the user performs an input operation of specifying the type and width of the web W. When the start of the initial operation is instructed by the user operation, the controller 6 executes the initial operation.

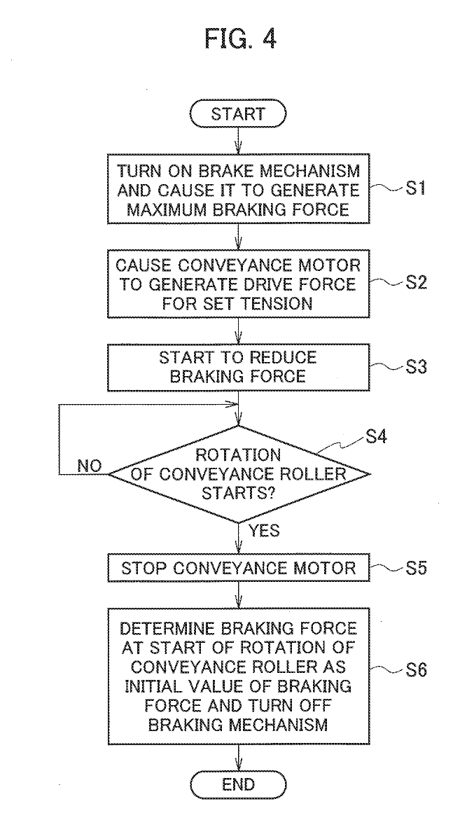

FIG. 4 is a flowchart for explaining the initial operation. When the start of the initial operation is instructed by the user operation as described above, in step S1 of FIG. 4, the controller 6 turns on the brake mechanism 12 and causes it to generate the predetermined maximum braking force.

Here, the maximum braking forces is set as braking force (torque) at which the web roll 7 does not rotate even when the set tension Fs is applied to the web W.

A method of determining the maximum braking force is described.

Assuming that the torque (braking force) of the brake mechanism 12 is T, the outer diameter of the web roll 7 is D, rotating tension for the torque T of the brake mechanism 12 is Fm, and a reduction ratio (gear ratio) between the brake mechanism 12 and the web roll support shaft 11 is Gb, the following formula (1) is established.

Fm=T×(2/D)×Gb (1)

The rotating tension Fm is tension of the web Win a state where the web roll 7 is made to rotate by the tension of the web W with the torque T generated by the brake mechanism 12. Specifically, the rotating tension Fm is tension of the web W at the moment when the web roll 7 starts to rotate in the case where the tension of the web W is gradually increased with the torque T generated by the brake mechanism 12.

Assuming that the torque T corresponding to the maximum braking force is maximum torque Tm, the initial outer diameter of the web roll 7 is Da, and the rotating tension Fm in a state where the outer diameter D of the web roll is the initial outer diameter Da and the maximum torque Tm is generated by the brake mechanism 12 is initial rotating tension Fma, the following formula (2) is established.

Fma=Tm×(2/Da)×Gb (2)

The aforementioned formula (2) is a formula in which Fma, Tm, and Da are plugged into Fm, T, and D of the formula (1). Moreover, the initial outer diameter Da of the web roll 7 is the outer diameter D in the state where the web roll 7 is set (initial state).

From the formula (2), it is found that the larger the initial outer diameter Da of the web roll 7 is, the smaller the initial rotating tension Fma is. Accordingly, the maximum torque Tm corresponding to the maximum braking force is determined to be a value at which the initial rotating tension Fma is greater than the set tension Fs, the initial rotating tension Fma being tension in the case where the initial outer diameter Da is the outer diameter of the largest new web roll 7 usable in the printing apparatus 1.

The maximum braking force (maximum torque Tm) is thereby set to braking force (torque) at which the web roll 7 does not rotate in the initial state even when the set tension Fs is applied to the web W, irrespective of the initial outer diameter Da, as long as the web roll 7 is a roll usable in the printing apparatus 1.

In this case, the relationship between an electrical current supplied to the brake mechanism 12 and the torque generated by the brake mechanism 12 is determined based on the characteristics of the brake mechanism 12. Accordingly, the controller 6 can set the braking force of the brake mechanism 12 to the maximum braking force (maximum torque Tm) by supplying an electrical current corresponding to the maximum torque Tm to the brake mechanism 12.

Next, in step S2, the controller 6 causes the conveyance motor 34 to generate the drive force (torque) for the set tension Fs. In this case, the controller 6 reads the value of the set tension Fs depending on the type and width of the web W specified by the user operation from the set tension table and causes the conveyance motor 34 to generate the drive force for the read set tension Fs.

In this case, the torque Tr equivalent to the drive force of the conveyance motor 34 for the set tension Fs is expressed by the following formula (3).

Tr=Fs×ϕ/(2×Gr) (3)

In this formula, ϕ is the diameter of the conveyance roller 33 driven by the conveyance motor 34. Gr is the reduction ratio between the conveyance motor 34 and the conveyance roller 33.

The relationship between an electrical current supplied to the conveyance motor 34 and the torque generated by the conveyance motor 34 is determined based on the characteristics of the conveyance motor 34. Accordingly, the controller 6 can cause the conveyance motor 34 to generate the drive force (torque Tr) for the set tension Fs by supplying an electrical current corresponding to the aforementioned torque Tr to the conveyance motor 34.

In this case, since the maximum braking force (maximum torque Tm) of the brake mechanism 12 is set as described above, the web roll 7 does not start to rotate at this point even when the conveyance motor 34 is made to generate the drive force (torque) for the set tension Fs.

Next, in step S3, the controller 6 starts reduction of the braking force (torque) of the brake mechanism 12. Then, the controller 6 gradually reduces the braking force of the brake mechanism 12.

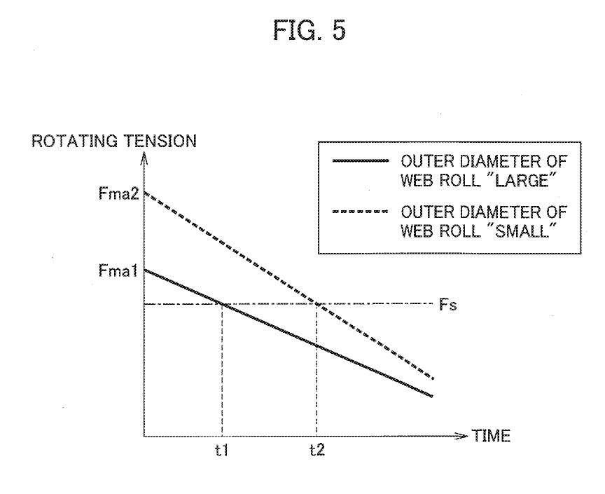

As apparent from the formula (1), when the torque T (braking force) of the brake mechanism. 12 is gradually reduced, as illustrated in FIG. 5, the rotating tension gradually decreases.

Note that FIG. 5 illustrates changes in the rotating tension Fm in the case where the outer diameter D of the web roll 7 is “large” and in the case where the outer diameter D is “small.” As apparent from the formula (2), an initial rotating tension Fma1 in the case where the outer diameter D is “large” is smaller than an initial rotating tension Fma2 in the case where the outer diameter D is small.

Meanwhile, as described above, the conveyance motor 34 generates the drive force (torque) for the set tension Fs.

Accordingly, when the rotating tension Fm gradually decreases with the reduction of the torque T of the brake mechanism 12 and eventually falls to the same level as the set tension Fs, the conveyance rollers 33 and the web roll 7 start to rotate due to the drive force of the conveyance motor 34. Specifically, in the example of FIG. 5, the conveyance rollers 33 and the web roll 7 start to rotate at a time point t1 when the outer diameter D of the web roll 7 is “large,” and start to rotate at a time point t2 when the outer diameter D of the web roll 7 is “small.”

Returning to FIG. 4, after starting the reduction of the braking force of the brake mechanism 12, in step S4, the controller 6 determines whether the rotation of the conveyance rollers 33 starts. In this case, the controller 6 determines that the rotation of the conveyance rollers 33 starts together with rotation of the output shaft of the conveyance motor 34 when the controller 6 receives a predetermined number of pulse signals from the encoder 35. In this case, the predetermined number of pulse signals is set to a value at which the rotation angle of the web roll 7 (conveyance amount of the web W) can be suppressed to the minimum within a range in which the rotation of the web roll 7 is detectable. When the controller 6 determines that the rotation of the conveyance rollers 33 is not started (step S4: NO), the controller 6 repeats step S4.

When the controller 6 determines that the rotation of the conveyance rollers 33 starts (step S4: YES), in step S5, the controller 6 stops the conveyance motor 34.

Next, in step S6, the controller 6 determines the braking force (torque) of the brake mechanism 12 at the start of the rotation of the conveyance rollers 33 as an initial value Ta of the braking force and holds the initial value Ta. Moreover, the controller 6 turns off the brake mechanism 12. The initial operation is thereby completed.

In this case, since the initial value Ta is determined in the initial operation as described above, the initial value Ta is the value of the torque T depending on the initial outer diameter Da of the web roll 7 and the set tension Fs. Specifically, the initial value Ta is expressed by the following formula (4).

Ta=Fs×Da/(2×Gb) (4)

Next, description is given of the first print operation performed after the web roll 7 is newly set on the web roll support shaft 11 and the initial operation is completed.

When a print job is inputted from an external apparatus such as a personal computer with the aforementioned initial operation completed, the controller 6 executes the print operation.

When the print job is inputted, the controller 6 first turns on the brake mechanism 12 and sets the braking force (torque) of the brake mechanism 12 to the initial value Ta determined in the aforementioned initial operation.

Next, the controller 6 starts the drive of the conveyance motor 34 and the rewinding motor 47 to start conveyance of the web W for the printing.

When the conveyance of the web W is started, the controller 6 increases the speed of conveying the web W with the conveyance rollers 33 at predetermined acceleration from the start of conveyance.

Then, when the speed of conveying the web W with the conveyance rollers 33 reaches a predetermined print conveyance speed Vg, the controller 6 controls the conveyance motor 34 and the rewinding motor 47 such that the conveyance transitions to constant speed conveyance of the web W at the print conveyance speed Vg from this moment.

After the start of the constant speed conveyance of the web W at the print conveyance speed Vg, the controller 6 starts the printing based on the print job by using the printers 4A, 4B.

After the start of the constant speed conveyance of the web W at the print conveyance speed Vg, the controller 6 controls the conveyance motor 34 such that the conveyance speed of the web W is maintained to be constant at the print conveyance speed Vg, based on the output pulse signals of the encoder 35. The conveyance speed of the web W is maintained to be constant to prevent deviation of landing positions of the inks ejected from the head units 41 to the web W and achieve excellent print image quality.

Specifically, the controller 6 calculates the number of revolutions of the conveyance motor 34 based on the output pulse signals of the encoder 35 and calculates the conveyance speed of the web W corresponding to the calculated number of revolutions. Then, the controller 6 controls the conveyance motor 34 such that the difference between the calculated conveyance speed and the print conveyance speed Vg is eliminated. The speed of conveying the web W with the conveyance motor 34 is thereby controlled to match the print conveyance speed Vg.

In this case, at the start of the constant speed conveyance of the web W at the print conveyance speed Vg, a decrease amount of the outer diameter D of the web roll 7 from the start of the conveyance of the web W is small. Specifically, the outer diameter D of the web roll 7 is substantially the same until the start of the constant speed conveyance of the web W at the print conveyance speed Vg. Accordingly, the braking force (torque) of the brake mechanism 12 is set to the initial value Ta until the start of the constant speed conveyance of the web W at the print conveyance speed Vg.

As time elapses from the start of conveyance of the web W, the outer diameter D of the web roll 7 gradually becomes smaller. In this respect, the controller 6 calculates the outer diameter D of the web roll 7 in real time during a period of the constant speed conveyance of the web W at the print conveyance speed Vg and sets the torque T depending on the result of this calculation in the brake mechanism 12 in real time.

Specifically, the controller 6 calculates the number of revolutions of the brake mechanism 12 (number of revolution of the brake gear 12b) in real time based on an output signal of the brake gear sensor 14 and converts the calculated number of revolutions into the number of revolutions N of the web roll 7. Then, the controller 6 calculates the outer diameter D of the web roll 7 from the following formula (5) by using the number of revolutions N of the web roll 7 and the print conveyance speed Vg.

D=Vg/(N×π) (5)

Then, the controller 6 calculates the torque T depending on the outer diameter D of the web roll 7 from the following formula (6) and sets the calculated torque T in the brake mechanism 12.

T=Fs×D/(2×Gb) (6)

Changing the torque T of the brake mechanism 12 depending on the decrease of the outer diameter D of the web roll 7 in real time as described above maintains the tension of the web W at the set tension Fs.

When the printing based on the print job is completed, the controller 6 stops the conveyance motor 34 and the rewinding motor 47 and terminates the conveyance of the web W. The series of operations in printing is thereby completed.

There is a case where the print operation based on the print job is completed in the middle of the web roll 7. Moreover, there is a case where the print operation based on the next print job is performed by continuously using this web roll 7 without removing it. In this case, it is only necessary to continuously set the braking force of the brake mechanism 12 at the start of the conveyance of the web W in the print operation based on the next print job, to the same braking force at the completion of the previous print job. This is because the outer diameter D of the web roll 7 at the start of the print operation based on the next print job is the same as the outer diameter D of the web roll 7 at the completion of the previous print job.

When the web roll 7 is newly set on the web roll support shaft 11 and then the print job is inputted without the start of the initial operation being instructed by the user operation, the controller 6 automatically executes the initial operation and then executes the print operation.

As described above, in the printing apparatus 1, when the web roll 7 is set on the web roll support shaft 11, the controller 6 executes the initial operation of: causing the brake mechanism 12 to generate the maximum braking force while causing the conveyance motor 34 to generate the drive force for the set tension Fs and, from this state, gradually reducing the braking force of the brake mechanism 12; and determining the braking force at the moment when the conveyance rollers 33 start to rotate as the initial value of the braking force in the conveyance of the web W.

The braking force depending on the initial outer diameter Da of the web roll 7 can be thereby set in the brake mechanism 12 without conveying the web W for roll diameter calculation, at the start of the conveyance of the web W in the case where the web roll 7 is newly set. Accordingly, it is possible to reduce the amount of web W to be wasted (waste paper).

Moreover, the braking force depending on the initial outer diameter Da of the web roll 7 can be set in the brake mechanism 12 without detecting the outer diameter of the newly-set web roll 7 by using a sensor or the like. Accordingly, there is no need to provide the sensor or the like for detecting the outer diameter of the web roll 7 and an increase in the complexity of the apparatus configuration can be avoided.

Moreover, the braking force depending on the initial outer diameter Da of the web roll 7 can be set in the brake mechanism 12 without inputting the initial outer diameter Da of the web roll 7 by performing the user operation. Accordingly, a decrease in the convenience of the user can be avoided.

Accordingly, the printing apparatus 1 can avoid an increase in the complexity of the apparatus configuration and a decrease in the convenience of the user while reducing the amount of web to be wasted.

When the initial value of the braking force is to be set based on the initial outer diameter Da of the web roll 7 calculated by conveying the web W for roll diameter calculation unlike in the embodiment, the outer diameter D of the web roll 7 is unknown during the conveyance of the web W for roll diameter calculation. Accordingly, the web W is conveyed for roll diameter calculation with the braking force set to force inappropriate for the outer diameter D of the web roll 7. Accordingly, there is a risk that, in the conveyance of the web W for roll diameter calculation, the web W is damaged due to excessive tension or a slack is formed in the web W due to insufficient tension and the web W comes into contact with the inkjet heads.

Meanwhile, in the embodiment, no conveyance of the web W for roll diameter calculation is performed. Accordingly, it is possible to avoid failures such as those described above caused by the conveyance of the web W for roll diameter calculation performed with inappropriate braking force.

Moreover, in the embodiment, the controller 6 sets (determines) the set tension Fs to the value depending on the type and width of the web W. The initial value of the braking force and the braking force in the conveyance of the web W can be thereby set to the values depending on the type and width of the web W. As a result, it is possible to prevent the case where the web W is damaged due to excessive tension or a slack is formed in the web W due to insufficient tension and the web W comes into contact with the inkjet heads in the conveyance of the web W.

Note that, although the set tension Fs is set to the value depending on the type and width of the web W in the aforementioned embodiment, the set tension Fs may be set to a value corresponding one of the type and width of the web W.

The embodiment of the present disclosure has, for example, the following configuration.

A conveying device includes: a web roll support shaft configured to rotatably support a web roll; a brake configured to apply a braking force to the web roll support shaft; a conveyance roller configured to convey a web while unwinding the web from the web roll; a conveyance motor configured to drive the conveyance roller; and a controller configured to drive the brake and the conveyance motor such that the web is unwound and conveyed from the web roll by the conveyance roller while the braking force is applied to the web roll support shaft to brake rotation of the web roll and thereby apply a predetermined tension to the web in printing. Upon the web roll being set on the web roll support shaft, the controller is configured to: drive the brake to apply the braking force of a first value to the web roll support shaft, the first value being a value at which the web roll does not rotate when the predetermined tension is applied to the web, and drive the conveyance motor to generate a drive force for the predetermined tension; drive the brake with the drive force generated to gradually reduce the braking force from the first value while determining whether rotation of the conveyance roller starts; and upon determining that the rotation of the conveyance roller starts, determine a second value of the braking force as an initial value of the braking force in conveyance of the web for the printing, the second value being a value at which the rotation of the conveyance roller starts.

The controller may be configured to determine the predetermined tension to be a value depending on at least one of a type of the web or a width of the web.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A conveying device comprising:
a web roll support shaft configured to rotatably support a web roll;
a brake configured to apply a braking force to the web roll support shaft;
a conveyance roller configured to convey a web while unwinding the web from the web roll;
a conveyance motor configured to drive the conveyance roller; and
a controller configured to drive the brake and the conveyance motor such that the web is unwound and conveyed from the web roll by the conveyance roller while the braking force is applied to the web roll support shaft to brake rotation of the web roll and thereby apply a predetermined tension to the web in printing,
wherein, upon the web roll being set on the web roll support shaft, the controller is configured to
drive the brake to apply the braking force of a first value to the web roll support shaft, the first value being a value at which the web roll does not rotate when the predetermined tension is applied to the web, and drive the conveyance motor to generate a drive force for the predetermined tension,
drive the brake with the drive force generated to gradually reduce the braking force from the first value while determining whether rotation of the conveyance roller starts, and
upon determining that the rotation of the conveyance roller starts, determine a second value of the braking force as an initial value of the braking force in conveyance of the web for the printing, the second value being a value at which the rotation of the conveyance roller starts.

2. The conveying device according to claim 1, wherein the controller is configured to determine the predetermined tension to be a value depending on at least one of a type of the web or a width of the web.
